(19) United States
(12) Patent Application Publication
(10) Pub. No.: US 2007/0144332 A1
(43) Pub. Date: Jun. 28, 2007

(54) TENSION CONTROL DEVICE USED ON A DRUM

(76) Inventor: Kuo-Chang Chen, Taichung Hsien (TW)

Correspondence Address: Rabin & Berdo, P.C., Suite 500, 1101 14th Street, Washington, DC, 20005, US

(21) Appl. No.: 11/342,696

(22) Filed: Jan. 31, 2006

(30) Foreign Application Priority Data
Dec. 23, 2005 (TW) 094222489

(51) Int. Cl. G10D 13/02

(52) U.S. Cl. 84/422.1

(57) ABSTRACT

A tension control device is used on a drum having a drum shell, two drum hoops and two drumheads, is mounted on the drum shell and has two mounting posts, a connector, two locking sleeves and two adjusting bolts. The mounting posts are mounted on the drum shell, and each mounting post has a longitudinal hole, a transverse hole and a setscrew. The connector is mounted between the mounting posts and has two connecting tubes and a threaded connecting stud. The connecting tubes are mounted through the transverse holes, and each connecting tube has a nipple and a threaded connector. The locking sleeves are mounted respectively in the threaded connectors. The adjusting bolts are screwed respectively into the connecting tubes, and the proximal ends of the adjusting bolts extend through the nipples, screw into the threaded connectors and engage the locking sleeves.

### BACKGROUND OF THE INVENTION

1. Field of the Invention The present invention relates to a tension control device, and more particularly relates to a drumhead tension control device used on a drum to adjust tension on drumheads mounted respectively in two drum hoops.

2. Description of Related Art With reference to FIG. 5, a conventional drum (70) normally comprises a cylindrical drum shell (71), two annular drum hoops (72), two drumheads (73) and multiple tension control devices (60). The cylindrical drum shell (71) includes two round openings and an outer surface. The annular drum hoops (72) are mounted respectively on the two openings in the cylindrical drum shell (71), and each annular drum hoop (72) has multiple adjustment holes. The adjustment holes are formed through the annular drum hoops (72). The drumheads (73) are mounted respectively in the annular drum hoops (72), cover the two openings, are made of leather or similar resilient material and emit a tone depending on tension of the drumheads (73). The tension control devices (60) are mounted on the outer surface of the drum shell (71) between the two annular drum hoops (72) and align with corresponding an adjustment hole in opposite annular drum hoops (72). The tension control devices (60) control the tone of the drumheads (73) by pulling the two drum hoops (72) together to increase the tension on and the tone of the drumheads (73) or releasing the drum hoops (72) to decrease the tension on and the tone of the drumheads (73).

With reference to FIG. 6, a conventional tension control device (60) has a mounting post (61), a connector (63), a setscrew (62) and two adjusting bolts (64). The mounting post (61) is mounted on the outer surface of the shell (71), and has a proximal end, a distal end, a longitudinal hole (611) and a transverse hole (612). The proximal end of the mounting post (61) is attached to the drum shell (71). The longitudinal hole (611) is threaded and is defined axially through the proximal end into the mounting post (61). The transverse hole (612) is formed diametrically through the mounting post (61) near the distal end and communicates with the longitudinal hole (611). The connector (63) is tubular, is mounted through the transverse hole (612) and has a middle, two open ends, an attachment hole (631) and an internal thread. The attachment hole (631) extends transversely through the connector (63) at the middle, and the internal thread is defined longitudinally in the connector (63). The setscrew (62) is screwed into the longitudinal hole (611) in the mounting post (61) and the attachment hole (631) in the connector (63) to securely hold the connector (63) in the transverse hole (612) of the mounting post (61). The adjusting bolts (64) are mounted respectively through the adjustment holes in the drum hoops (72) and are screwed respectively into opposite ends of the connector (63). Each adjusting bolt (64) has a proximal end, a distal end, a flange (641) and an external thread. The flange (641) is formed near the distal end of the adjusting bolt (64), and the thread is formed on the adjusting bolt (64) and communicates with the proximal end. The proximal ends of the adjusting bolts (64) screw respectively into the open ends of the connector (63) to pull the drum hoops (72) closer together or release the drum hoops (72) and adjust the tension on the drumheads (73).

However, the adjusting bolts (64) of the tension control device (60) for a drum (70) may loosen from the connector (63) by the vibration of the drum hoops (72) and the drumheads (73). Then, the tone of the drumheads (73) inadvertently changes, which reduces the effectiveness of the control tension device (60) for a drum (70) in use.

Therefore, the invention provides a tension control device to mitigate or obviate the aforementioned problems.

### SUMMARY OF THE INVENTION

The main objective of the present invention is to provide a tension control device for a drum that can prevent the adjusting bolts from loosening because of vibration of the drum in use.

A tension control device in accordance with the present invention is used on a drum having a drum shell, two drum hoops and two drumheads, is mounted on the drum shell and has two mounting posts, a connector, two locking sleeves and two adjusting bolts. The mounting posts are mounted on the drum shell, and each mounting post has a longitudinal hole, a transverse hole and a setscrew. The connector is mounted between the mounting posts and has two connecting tubes and a threaded connecting stud. The connecting tubes are mounted through the transverse holes, and each connecting tube has a nipple and a threaded connector. The locking sleeves are mounted respectively in the threaded connectors. The adjusting bolts are screwed respectively into the connecting tubes, and the proximal ends of the adjusting bolts extend through the nipples, screw into the threaded connectors and engage the locking sleeves.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a tension control device in accordance with the present invention;

FIG. 2 is an exploded perspective view of the tension control device in FIG. 1;

FIG. 3 is an exploded perspective view of the tension control device for a drum in FIG. 1 mounted on a drum;

FIG. 4 is a side view in partial section of the tension control device that in FIG. 1 mounted on a drum;

FIG. 5 is a perspective view of a drum with conventional tension control devices in accordance with the prior art;

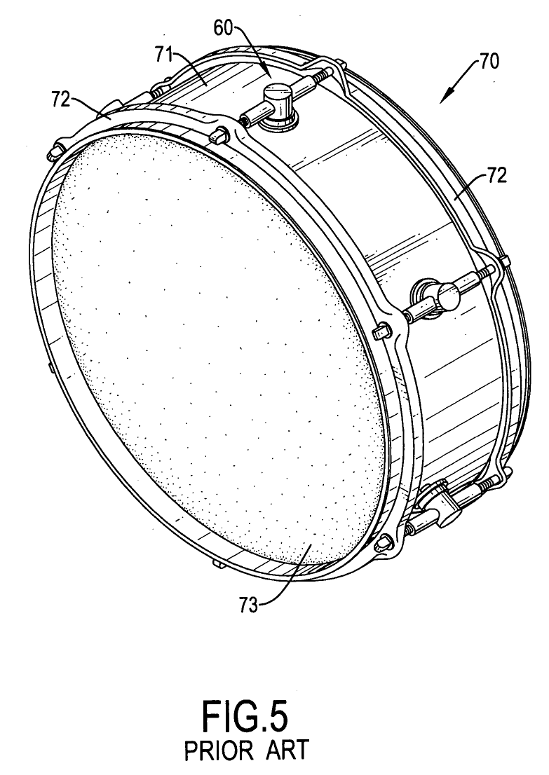

FIG. 6 is a side view in partial section of a conventional tension control device that in FIG. 5 mounted on a drum.

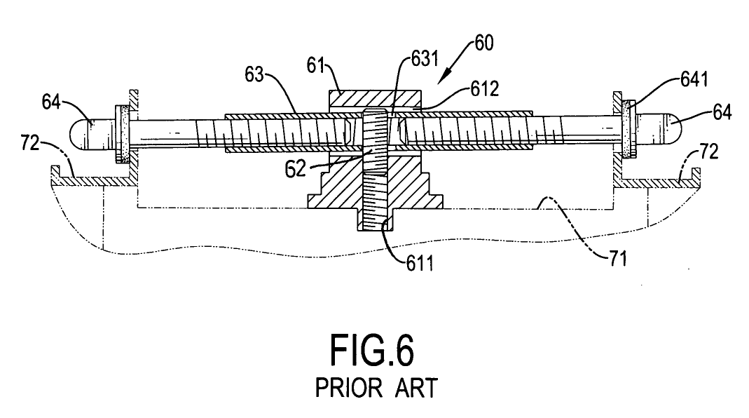

### DETAILED DESCRIPTION OF THE PREFERRED EMBODIMENT

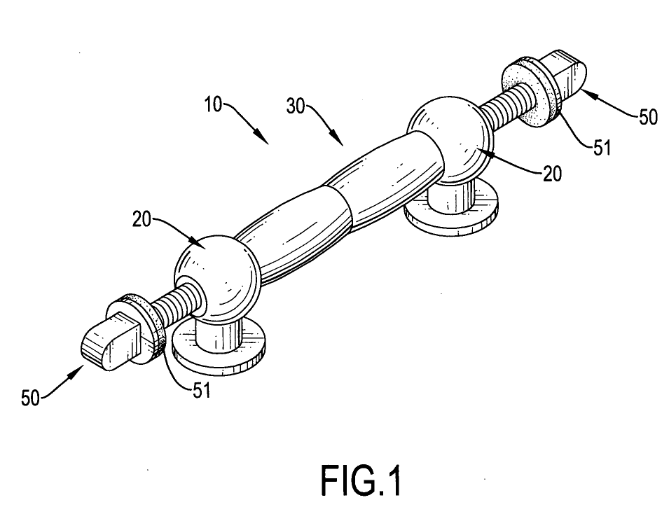

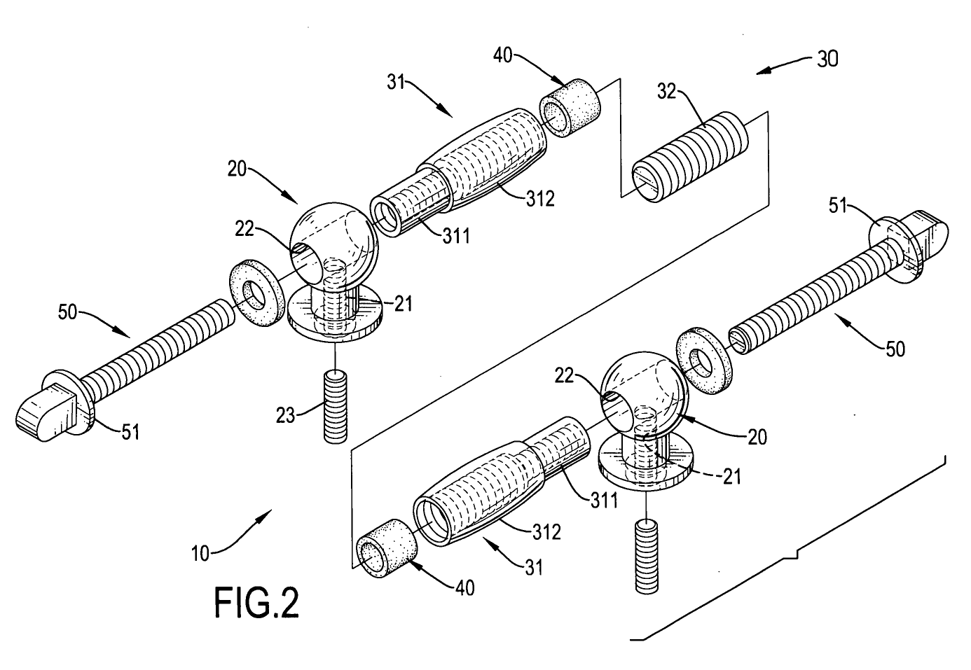

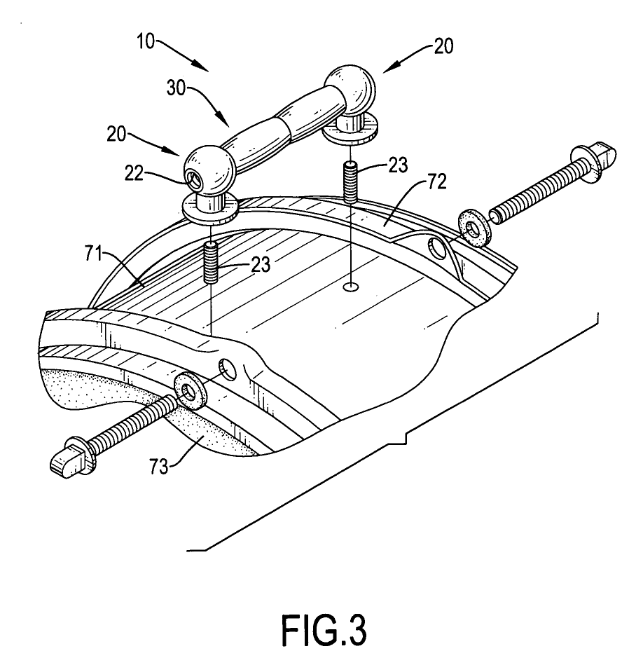

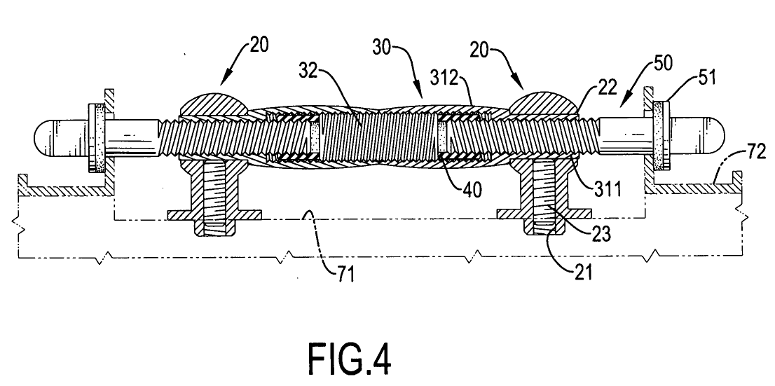

With reference to FIGS. 1 to 4, a tension control device (10) in accordance with the present invention is used on a drum (70) having a cylindrical drum shell (71), two annular drum hoops (72) and two drumheads (73), and comprises two mounting posts (20), a connector (30), two locking sleeves (40) and two adjusting bolts (50).

The mounting posts (20) are mounted in longitudinal pairs on the cylindrical drum shell (71) parallel to each other, and each mounting post (20) has a proximal end, a distal end, a longitudinal hole (21), a transverse hole (22) and a setscrew (23). The proximal end is attached to the cylinder drum shell (71). The longitudinal hole (21) is defined through the proximal end axially into the mounting post (20). The transverse hole (22) is formed diametrically through the mounting post (20) near the distal end and communicates with the longitudinal hole (21). The setscrew (23) is screwed into the longitudinal hole (21) in the mounting post (20) and extends into the transverse hole (22). The connector (30) is mounted between the mounting posts (20) and has two connecting tubes (31) and a threaded connecting stud (32). The connecting tubes (31) are hollow and are mounted respectively through the transverse holes (22) in the mounting posts (20), and each connecting tube (31) has two open ends, a nipple (311) and a threaded connector (312). The nipples (311) are mounted respectively in the transverse holes (22) in the mounting posts (20) and are held securely in the transverse holes (22) by the setscrews (23) screwed into the longitudinal holes (21), extending into the transverse holes (22) and pressing against the nipples (311). The threaded connectors (312) are formed respectively on the nipples (311) and are mounted facing each other, and each threaded connector (312) has an internal thread and a shoulder. The threaded connecting stud (32) is screwed into the internal threads in the threaded connectors (312) to hold the connecting tubes (31) together.

The locking sleeves (40) are made of plastic and are mounted in the threaded connectors (312) between the shoulders respectively in the threaded connectors (312) and the threaded connecting stud (32), and each locking sleeve (40) has an open inner end, an open outer end, an inner surface and an outer surface. The open inner end abuts the threaded connecting stud (32). The outer surfaces of the locking sleeves (40) contact with the internal threads in the threaded connectors (312).

The adjusting bolts (50) are mounted respectively through corresponding through holes respectively in opposite drum hoops (72) and are screwed respectively into the nipples (312) of the connecting tubes (31) and the locking sleeves (40). Each adjusting bolt (50) has a proximal end, a distal end, a flange (51) and an external thread. The proximal ends of the adjusting bolts (50) screw respectively through the nipples (311) to adjust tension on the drumheads (73) and extend respectively into the inner surfaces of the locking sleeves (40) to hold the adjusting bolts (50) securely in place. The flange (51) is formed near the distal end of the adjusting bolt (50), and the external thread is formed around the adjusting bolt (50) and communicates with the proximal end. Consequently, the tone of the drumheads (73) would not change as a result of vibration of the drum. With the arrangement of the resilient locking sleeves (40), the adjusting bolts (50) can be kept from unintentionally releasing from the nipples (311). Accordingly, to adjust the tone of the drumheads of a drum before playing the drum is not necessary.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tension control device used on a drum having a cylindrical drum shell, two annular drum hoops and two drumheads, and the tension control device having
two mounting posts mounted in longitudinal pairs and parallel to each other, and each mounting post having
a proximal end;
a distal end;
a longitudinal hole defined through the proximal end axially into the mounting post;
a transverse hole formed diametrically through the mounting post near the distal end and communicated with the longitudinal hole; and
a setscrew screwed into the longitudinal hole in the mounting post and extended into the transverse hole;
a connector mounted between the mounting posts and having
two connecting tubes being hollow and mounted respectively through the transverse holes in the mounting posts, and each connecting tube having
two open ends;
a nipple securely mounted in the transverse hole in a corresponding mounting post and held securely in the transverse hole by a corresponding setscrew; and
a threaded connector formed on the nipple, mounted facing the other threaded connector and having
an internal thread; and
a shoulder; and
a threaded connecting stud screwed into the internal threads in the threaded connectors to hold the connecting tubes together;
two locking sleeves mounted in the threaded connectors between the shoulders respectively in the threaded connectors and the threaded connecting stud, and each locking sleeve having
an open inner end abut the threaded connecting stud;
an open outer end;
an inner surface; and
an outer surface contacted with engaged the internal thread in the threaded connectors; and
two adjusting bolts adapted for being mounted respectively through the through holes in opposite drum hoops and screwed respectively into the nipples of the connecting tubes and the locking sleeves, and each adjusting bolt having
a proximal end screwing through a corresponding nipple to adjust tension on the drumheads and extending into the inner surface of a corresponding one of the locking sleeves to hold the adjusting bolt securely in place;
a distal;
a flange formed near the distal end of the adjusting bolt; and
an external thread formed around the adjusting bolt and communicated with the proximal end.

2. The tension control device as claimed in claim 1, wherein the locking sleeves are made of plastic.
